(19) United States
(12) Patent Application Publication
(10) Pub. No.: US 2026/0357877 A1
(43) Pub. Date: Nov. 12, 2026

(54) SINTERED TOOTHED BELT WHEEL

(71) Applicant: Miba Sinter Austria GmbH, Laakirchen (AT)

(72) Inventors: Christian KRONBERGER, Vorchdorf (AT); Martin OHLER, Vorchdorf (AT); Horst RÖSSLER, Krenglbach (AT)

(73) Assignee: Miba Sinter Austria GmbH, Laakirchen (AT)

(21) Appl. No.: 19/629,061

(22) Filed: Mar. 26, 2026

(30) Foreign Application Priority Data
May 9, 2025 (AT) A50313/2025

(51) Int. Cl. F16H 7/02; B22F 5/08

(52) U.S. Cl. CPC F16H 7/023; B22F 5/08

(57) ABSTRACT

A sintered toothed belt wheel has a one-piece, hollow cylindrical wheel body on which a first track and a second track for toothed belts are formed, wherein the first track has a first face toothing and the second track has a second face toothing, and wherein a collar projecting beyond the tracks in the radial direction is formed between the first track and the second track with a collar head portion, wherein the collar head portion is formed with a cross-sectional taper and/or with rounded edges.

### CROSS REFERENCE TO RELATED APPLICATIONS

Applicant claims priority under 35 U.S.C. §119 of Austrian Application No. A50313/2025 filed May 9, 2025, the disclosure of which is incorporated by reference.

### BACKGROUND OF THE INVENTION

### 1. Field of the Invention

The invention relates to a sintered toothed belt wheel with a one-piece, hollow cylindrical wheel body on which a first track and a second track for toothed belts are formed, wherein the first track has a first face toothing and the second track has a second face toothing, and wherein a collar with a collar head portion projecting beyond the tracks in the radial direction is formed between the first track and the second track.

The invention also relates to a belt-type rack-and-pinion drive comprising a first motor, in particular an electric motor, and a second motor, in particular an electric motor, wherein the first motor is connected to a first toothed belt with a sintered toothed belt wheel and the second motor is connected to a second toothed belt with a sintered toothed belt wheel for torque transmission.

Furthermore, the invention relates to a method for producing a sintered toothed belt wheel, comprising the steps of: pressing a green compact from a sintering powder having a first track and a second track, wherein the first track has a first face toothing and the second track has a second face toothing, for which purpose the sintering powder is filled into a mold cavity of a die, and then the sintering powder is pressed with a upper punch and a lower punch to form the green compact, and the sintering powder is partially displaced into the upper punch after being filled into the die and the upper punch is used as a further die for forming the first track, wherein a collar with a collar head portion is formed between the two tracks of the toothed wheel with the upper punch and the lower punch, and the green compact is then sintered.

### 2. Description of the Related Art

AT 521 836 B1 describes a method for pressing a green compact from a sintering powder for the manufacture of a toothed wheel. The toothed wheel has a first track and a second track, wherein the first track has a first face toothing and the second track has a second face toothing. The sintering powder is filled into a mold cavity of a die and then pressed into a green compact using an upper punch and a lower punch, wherein the sintering powder is partially displaced into the upper punch after being filled into the die. The upper punch is used as an additional die for forming the first track. Furthermore, the upper punch and the lower punch form a web between the two tracks of the toothed wheel. The collar is removed again for most embodiments of toothed wheels. However, AT 521 836 B1 also describes that the web can also be retained as a so-called rim if the toothed wheel is to be used for a belt drive. Furthermore, this publication does not contain any further specific disclosure with regard to sintered toothed belt wheels, but mainly deals with embodiment variants of toothed wheels for which the web is removed again.

### SUMMARY OF THE INVENTION

The object of the present invention was to provide a one-piece, multi-track toothed belt wheel or a belt-type rack-and-pinion drive with improved operating characteristics.

The object of the invention is solved in the sintered toothed belt wheel mentioned at the beginning in that the collar head portion is formed with a cross-sectional taper and/or with rounded edges.

The object of the invention is also solved with the belt-type rack-and-pinion drive mentioned at the beginning, which has the sintered toothed belt wheel according to the invention.

Furthermore, the object of the invention is solved with the method mentioned at the beginning, according to which the collar head portion is formed with a cross-sectional taper and/or with rounded edges.

By tapering the collar head portion and/or rounding the edges, the running of the toothed belts can be improved. Due to the tapered or rounded portion of the collar head portion, the collar recedes into the "background" during belt tracking, so that contact between the collar and belt can be minimized. This in turn allows the belt to run more smoothly and therefore drive a component or driven unit driven by the belt drive more evenly. By manufacturing the sintered toothed belt wheel using sintering technology, it is possible to take into account the tapering of the collar head portion or the rounding of the edges during powder pressing to produce the green compact, which means that further machining of the collar for this/these embodiment(s) can be avoided. The manufacturing of the collar using sintering technology also has the advantage that the collar can be produced with a porosity that can give it a certain elasticity.

According to an embodiment variant of the invention, it may be provided that the collar has a width in the axial direction through the sintered toothed belt wheel which is selected from a range of 10 % to 350 % of a wall thickness of the wheel body. With this embodiment variant, re-forming or primary forming resp. producing the collar during powder pressing into a green compact is easier. In addition, more pronounced or multi-stage tapers can be produced more easily.

According to a further embodiment variant of the invention, it may be provided that an annular web projecting radially inwards beyond the inner lateral surface of the wheel body is arranged on an inner lateral surface of the wheel body. The annular web can be used as a contact element for a bearing or as an axial stop for easier positioning of the sintered toothed belt wheel on a shaft without a bearing, which means that the positioning accuracy of the sintered toothed belt wheel and thus the operation of the toothed belts can be made more precise.

According to an embodiment variant, the annular web can have a width in the axial direction through the sintered toothed belt wheel which is selected from a range of 55 % to 700 % of the width of the collar.

According to a further embodiment variant of the invention, it may be provided that the neutral axis through the annular web in the axial direction through the sintered toothed belt wheel is offset at a distance of 2 % to 500 % of the collar width from the neutral axis through the collar. Surprisingly, during operation of the sintered toothed belt wheel, it has been found that it is advantageous if the annular web is not arranged exactly below the collar in the radial direction, although one would assume that a better support of the collar could be achieved with the arrangement exactly below.

According to another embodiment variant of the invention, it may be provided that the first track and the second track are each configured as helical gearing and the two tracks form a double helical gearing. With this combination of gearing directions, axial belt forces can be generated, each acting against the collar, so that the toothed belts tend to shift in the direction of the collar in the event of misalignment. This eliminates the need for additional collars on the end faces of the sintered toothed belt wheel.

According to another embodiment variant of the invention, it may be provided that a tip circle of the first track has a first diameter and a tip circle of the second track has a second diameter, wherein a ratio of the first diameter to the second diameter is selected from a range of 1:1 to 1:2.

According to a further embodiment variant of the invention, it may be provided that the tooth gaps of the second track are offset by a value relative to the tooth gaps of the first track, which is selected from a range of 1 % to 99 %, based on the position of the tooth gaps of the first track. This makes it possible to reduce the vibrations of the belt-type rack-and-pinion drive during operation, which also enables a smoother operation of the belt-type rack-and-pinion drive.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows an embodiment variant of a belt-type rack-and-pinion drive;

FIG. 2 shows an embodiment variant of a sintered toothed belt wheel in oblique view;

FIG. 3 shows the sintered toothed belt wheel shown in FIG. 2 in longitudinal section;

FIG. 4 shows a detail of the sintered toothed belt wheel in the area of the collar;

FIG. 5 shows another embodiment variant of the sintered toothed belt wheel in top view;

FIG. 6 shows a further embodiment variant of the sintered toothed belt wheel in top view;

FIG. 7 shows a first method step for producing a green compact for the sintered toothed belt wheel in a device for this purpose, shown in part;

FIG. 8 shows a second method step for producing a green compact for the sintered toothed belt wheel in a device for this purpose, shown in part;

FIG. 9 shows a third method step for producing a green compact for the sintered toothed belt wheel in a device for this purpose, shown in part; and

FIG. 10 shows a fourth method step for producing a green compact for the sintered toothed belt wheel in a device for this purpose, shown in part.

### DETAILED DESCRIPTION OF PREFERRED EMBODIMENTS

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

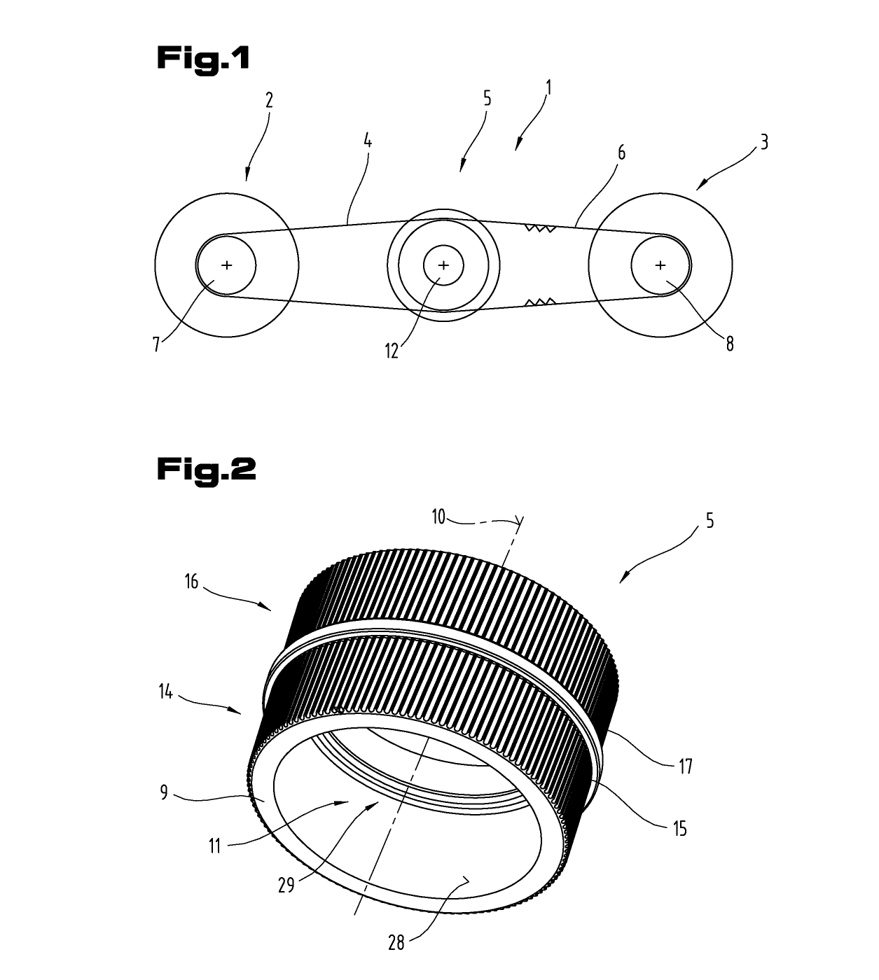

FIG. 1 shows an embodiment variant of a belt-type rack-and-pinion drive 1 in a simplified representation. The belt-type rack-and-pinion drive 1 is a toothed belt drive comprising a first motor, in particular an electric motor 2, and a second motor, in particular an electric motor 3, wherein the first motor is connected to a toothed belt 4 belt with a sintered toothed belt wheel 5 and the second motor is connected to a second toothed belt 6 with a sintered toothed belt wheel 5 for torque transmission.

The first motor, in particular the electric motor 2, and a second motor, in particular the electric motor 3, as well as the two toothed belts 4, 6 may be configured according to the state of the art, so that no further explanations are necessary.

Both toothed belts 4, 6 are connected to the same sintered toothed belt wheel 5 in a torque-transmitting manner, for which purpose the corresponding toothings (only indicated on the second toothed belt 6 in FIG. 1) engage with each other. The toothed belts 4, 6 also engage with toothed wheels 7 and 8 on the respective motor. The toothed wheel 7 is driven by the first motor and the toothed wheel 8 by the second motor. Any necessary speed adjustment can be carried out electronically via corresponding known control units.

The belt-type rack-and-pinion drive 1 may be used for steering assistance, for example, wherein the two motors (drives) can provide increased steering assistance. However, the belt-type rack-and-pinion drive 1 may also be used in other applications, such as for steer-by-wire applications or for applications in the field of autonomous driving.

FIGS. 2 and 4 show a first embodiment variant of the sintered toothed belt wheel 5.

The sintered toothed belt wheel 5 has a wheel body 9. A recess 11 extending in the axial direction 10, in particular through the sintered toothed belt wheel 5 (so that the wheel body 9 is hollow cylindrical), is formed in the wheel body 9 to receive a shaft 12 (see FIG. 1). The wheel body 9 is made in one piece. Furthermore, the wheel body 9 has a first track 14 with a first face toothing 15 and a second track 16 with a second face toothing 17 on its radially outer lateral surface 13.

The first track 14 / the first face toothing 15 is intended for the engagement of the first toothed belt 4. The first track 14 / the first face toothing 15 extends from a first face surface 18 of the wheel body 9 in the direction of, in particular up to, a collar 19. The collar 19 separates the first track 14 from the second track 16.

The second track 16 / the second face toothing 17 is intended for the engagement of the second toothed belt 6. The second track 14 / the second face toothing 17 extends from a second face surface 20 of the wheel body 9 in the direction of, in particular up to, the collar 19.

At least one of the two face toothings 15, 17, in particular both face toothings 15, 17, is designed as a spur toothing. However, at least one of the face toothings 15, 17 may also be configured differently, for example as a helical gearing as shown in FIG. 6. Preferably, the face toothings 15, 17 are configured as helical gearings.

The helical gearings of the two face toothings 15, 17 may have the same angle of inclination (helix angle). However, the two face toothings 15, 17 may also have different pitches and/or angles of inclination in relation to each other.

Just for the sake of completeness, it should be noted that the toothing of the toothed belts 4, 6 is adapted to the respective toothing of the first or second track 14, 16 that engages with it. If, for example, the first face toothing 15 is a spur toothing, then the first toothed belt 4 also has a spur toothing on its inner surface. If the first face toothing 15 is a helical gearing, then the first toothed belt 4 also has a helical gearing on its inner surface, wherein in this case the helix angles and pitches of the toothings are also the same.

If the face toothings 15, 17 are configured as helical gearings, it is conceivable that the two helical gearings have a different helix angle. This can go so far that the teeth of the two face toothings 15, 17 run in opposite directions, i.e. one of the face toothings 15, 17 has teeth that rise to the left and the second of the two face toothings 15, 17 has teeth that rise to the right. The two face toothings 15, 17 may then have the shape of a double helical gearing.

The collar 19, which is shown enlarged in FIG. 4, projects radially beyond the first and second face toothings 15, 17. A height 21 of the collar 19 measured from the tip circle diameter of the first or second face toothing 15, 17 may be between 1 mm and 10 mm.

The term "tip circle diameter" is used in the usual linguistic usage for toothed wheels.

The collar 19 has a collar head portion 22. The collar head portion 22 may extend over the entire height 21 of the collar 19 or only over a part of it, for example over a range between 10 % and 70 % of the height 21, measured from a radially outer collar surface 23.

The collar head portion 22 is formed with a cross-sectional taper and/or with rounded edges. The cross-sectional taper extends outwards in a radial direction as the diameter decreases.

The extent of the taper may be such that a collar width 24 decreases by a value from a range of 3 % to 40 %, in particular from a range of 10 % to 35 %, of the maximum collar width 24. The taper is preferably formed on both sides, but may also be formed on one side only.

The rounded edges are formed at the transition from the collar lateral surface 24 to the two collar end faces 25, 26. Preferably, both transitions are rounded, but it is also conceivable for only one of the two transitions to be rounded.

The transition(s) may also be configured with a chamfer instead of a rounding. This configuration is a variant of the cross-sectional taper of collar the collar 19. In this case, the chamfer extends over an area of the height 21 of the collar of at least 0.1 %, measured from the collar lateral surface 23.

The collar 19 may have the function of a so-called thrust washer. Preferably, at least one, in particular both, face toothings 15, 17 connect directly to the collar 19.

According to an embodiment variant, it may be provided that the collar width 24 in the axial direction 10 through the sintered toothed belt wheel 5 is selected from a range of 10 % to 350 %, in particular between 20 % and 250 %, of a wall thickness 27 of the wheel body 9. The wall thickness 27 of the wheel body 9 is measured at one of the two end faces 18, 20 of the wheel body 9. Preferably, the wall thickness 27 of the wheel body 9 is the same on both end faces 18, 20 of the wheel body 9. However, if the wall thickness 27 of the wheel body 9 is different on the two end faces 18, 20 of the wheel body 9, the smaller of the two is used to determine the collar width 24.

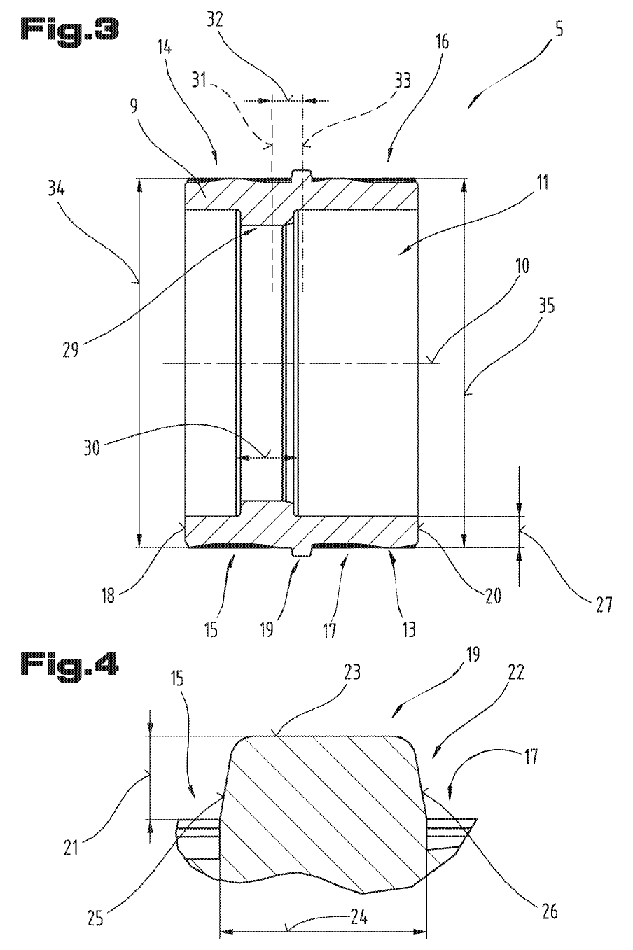

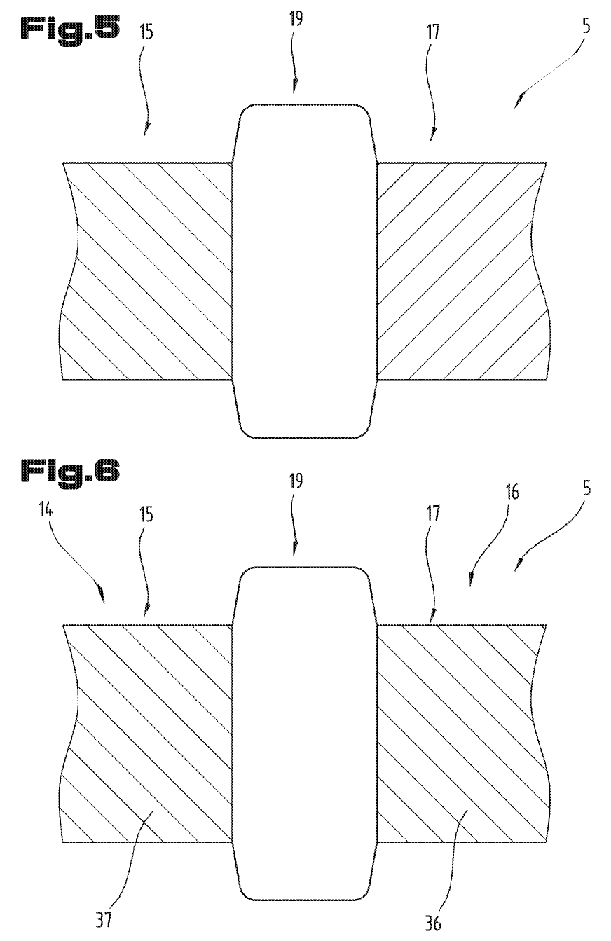

As can be seen from FIGS. 2 and 3, according to a further embodiment variant it may be provided that an annular web 29 projecting radially inwards beyond the inner lateral surface 28 is arranged on an inner lateral surface 28 of the wheel body 9. This annular web 29 may have a width 30 in the axial direction 10 through the sintered toothed belt wheel 5, which is selected from a range of 55 % to 700 % of the collar width 24.

It is conceivable that the annular web 29 is arranged in the radial direction exactly below the collar 19. According to a further embodiment variant, it may be provided that the neutral axis 31 through the annular web 29 in the axial direction 10 through the sintered toothed belt wheel 5 is offset at a distance 32 of 2 % to 500 % of the collar width 24 from the neutral axis 33 through the collar 19. For reasons of clarity only, the neutral axes 31, 33 are indicated as vertical stroke-dotted lines in FIG. 3.

However, the sintered toothed belt wheel 5 may also be configured without this annular web 29 or with a non-rotationally symmetrical shape of a projection projecting beyond the inner lateral surface 28.

The two face toothings 15, 17 preferably have the same tip circle diameter. According to an embodiment variant, however, it may be provided that a tip circle of the first track 14 has a first diameter 34 and a tip circle of the second track 16 has a second diameter 35, wherein a ratio of the first diameter 34 to the second diameter 35 is selected from a range of 1:1 to 1:2.

As shown in FIG. 6, it may be provided that the tooth gaps 36 of the second track 16 are offset by a value relative to the tooth gaps 37 of the first track 14, which is selected from a range from 1 % to 99 %, in particular from 10 % to 75 %, relative to the position of the tooth gaps 37 of the first track 14, wherein the two face toothing 15, 17 of the two tracks 14, 16 have the same pitch. This embodiment variant may therefore also be used for spur toothings.

The term "tooth gap" is used in the usual linguistic usage for toothed wheels.

The sintered toothed belt wheel 5 is produced by powder metallurgy from a, preferably metallic, sintering powder. The sintering powder may be a steel powder, for example, although other (pre-alloyed) powders may also be used. The powder may also contain the usual additives, such as lubricants, etc. In a first step, this (possibly premixed) sintering powder is pressed into a so-called green compact.

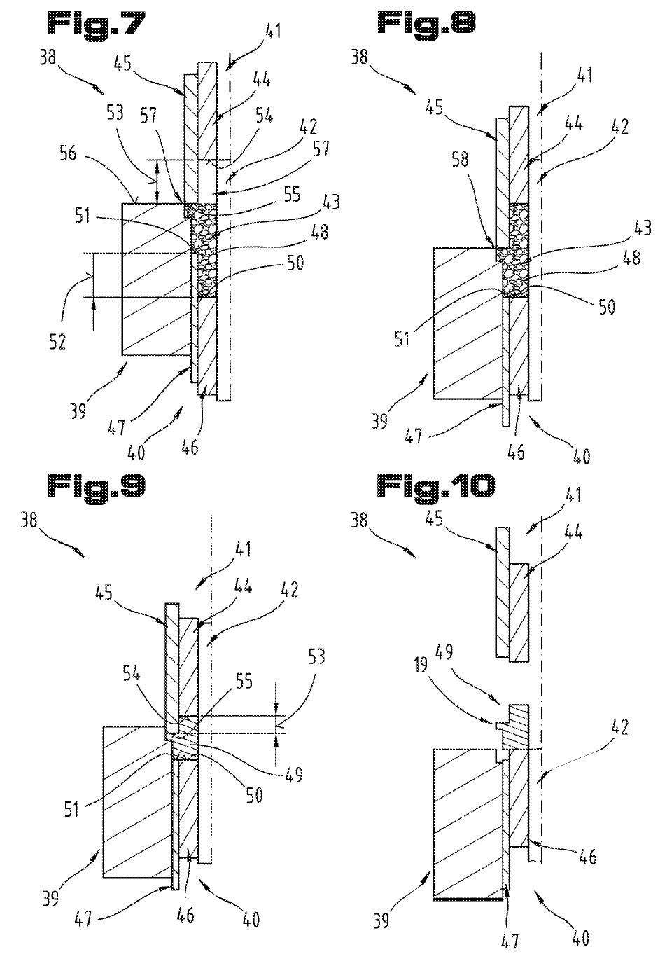

A preferred embodiment variant of a device 38 for producing the green compact for the sintered toothed belt wheel 5 is shown in excerpts in FIGS. 7-10. Since powder presses as such are known in sintering technology, other details of the powder press, such as drives, etc., are not shown, since these details are already familiar to the skilled person, for example from EP 1 952 975 A1.

The device 38 comprises a die 39, a lower punch 40 and an upper punch 41. A core rod 42 may be arranged to form the recess 11 in the sintered toothed belt wheel 5.

The die 39 has a mold cavity 43. The size of the mold cavity 43 is such that the lower punch 40 and the upper punch 41 can be partially introduced in it, as can be seen in FIGS. 7-10.

The upper punch 41 has a first upper punch part 44 and a second upper punch part 45 or consists of these two upper punch parts 44, 45, wherein the first upper punch part 44 is arranged inside the second upper punch part 45 when viewed in the radial direction, as can also be seen from FIGS. 7-10. The first upper punch part 44 can therefore also be referred to as the radially inner upper punch part 44 and the second upper punch part 45 as the radially outer upper punch part 45.

The lower punch 40 may be configured in one piece, especially if the die 39 is adjustable in the axial direction of the device 38 (in FIGS. 7-10 the vertical direction). In the preferred embodiment variant, however, the lower punch 40 has a first lower punch part 46 and a second lower punch part 47 or consists of these two lower punch parts 46, 47. The first lower punch part 46 is arranged inside the second lower punch part 47 when viewed in the radial direction, as can also be seen from FIGS. 7-10. The first lower punch part 46 can therefore also be referred to as the radially inner lower punch part 46 and the second lower punch part 47 as the radially outer lower punch part 47.

FIGS. 7-10 show the device 38 in various positions, namely in the filling position (FIG. 7), in the powder transfer position (FIG. 8), in the compacting position (FIG. 9) and in the ejecting position (FIG. 10).

In the filling position, a (metallic) sintering powder 48 is filled into the mold cavity 43 of the die 39 to produce a green compact 49 (FIG. 10) for the sintered toothed belt wheel 5. A pressing surface 50 of the first lower punch part 46 is arranged below a pressing surface 51 of the second lower punch part 47. A distance 52 between the pressing surface 50 of the first lower punch part 46 and the pressing surface 51 of the second lower punch part 47 is preferably as large as a distance 53 between a pressing surface 54 of the first upper punch part 44 and a pressing surface 55 of the second upper punch part 45, wherein the pressing surface 54 of the first upper punch part 44 is arranged in the axial direction above the pressing surface 55 of the second upper punch part 45 (FIG. 7). But the distance 52 may also be greater than the distance 53. With the embodiment variant in which the distance 52 is the same as the distance 53, a more even compaction of the green compact 49 can be achieved.

For the sake of completeness, it should be mentioned that the pressing surfaces 50, 51, 54 and 55 are used to press the sintering powder 48 into the green compact 49 and accordingly face the mold cavity 43 of the die 39.

FIG. 7 shows the device 38 already in the position with the sintering powder 48 filled in. In this position, the upper punch 41 is already lowered, so that the second upper punch part 45 is arranged with its pressing surface 55 at the level of an end face 56 of the die 39, but is not yet introduced in the die 39. The end face 56 of the die 39 is formed adjacent to the mold cavity 43, as can be seen in FIG. 7. During the filling of the sintering powder 48 into the mold cavity 43 of the die 39, the upper punch 41 is arranged at a distance from the die 39 in order to release the mold cavity 43.

In the position of the upper punch 41 shown in FIG. 7, the upper opening of the mold cavity 43 is closed by the upper punch 41 (and the core rod 42). Due to the spacing of the pressing surface 54 of the first upper punch part 44 from the pressing surface 55 of the second upper punch part 45, an additional mold cavity 57 is formed in this position, which is directly adjacent the mold cavity 43 of the die 39. The upper punch 41 thus forms another die for producing the sintered toothed belt wheel 5.

A part of the sintering powder 48 is displaced from the mold cavity 43 of the die 39 into this additional die. For this purpose, in the illustrated embodiment variant of the device 38, the first lower punch part 46 is displaced upwards, in particular to such an extent that the pressing surface 50 of the first lower punch part 46 is arranged at the same height as the pressing surface 51 of the second lower punch part 47. This position is illustrated in FIG. 8. As can be seen from this figure, the die 39 is used to produce the first track 14 with the first face toothing 15 (FIG. 3) and the other die (i.e. the upper punch 41) is used to produce the second track 16 with the second face toothing 17 (FIG. 3). Accordingly, the wall surrounding the mold cavity 43 of the die 39 has an internal toothing corresponding (complementary) to the formation of the first face toothing 15 and the radially inner surface of the second upper punch part 45, which also defines the mold cavity 57 of the further die, has an internal toothing corresponding (complementary) to the formation of the second face toothing 17. For the sake of clarity, these two face toothings 15, 17 are not further highlighted in FIGS. 7-10.

It should be noted that FIGS. 7-10 show the production of a green compact 49 for a sintered toothed belt wheel 5 with different diameters 34, 35 of the tip circles of the two toothings. For the production of a sintered toothed belt wheel 5, as shown in FIG. 2, in which the diameters 34, 35 of the tip circles are the same size, the radial position of the lower punch parts 46, 47 can be adjusted accordingly.

As can also be seen from FIGS. 7-10, the die 39 has a stepping 58 at the filling opening for the sintering powder 48. This stepping 58 serves to form a collar 19 on the green compact 49, as can be seen more clearly in FIG. 10.

If the annular web 29 is to be formed on the sintered toothed belt wheel 5, the lower punch 40 and the upper punch 41 may have corresponding additional parts that are adjustable relative to one another in the axial direction.

After the sintering powder 48 has been partially transferred to the upper punch 41, the sintering powder 48 is compacted to form the green compact 49. This step is shown in FIG. 9. For this purpose, the positions of the lower punch 40 and the upper punch 41 are changed so that the distance between the pressing surfaces 50, 51 of the lower punch 40 and the pressing surfaces 54, 55 of the upper punch 41 is reduced (preferably to the final dimension of the green compact 49 after compaction). The two lower punch parts 46, 47 of the lower punch 40 are preferably adjusted by the same amount so that their pressing surfaces 50, 51 remain at the same relative height to one another. The two upper punch parts 44, 45, on the other hand, are preferably adjusted to different distances, so that the distance 53 between the pressing surfaces 54, 55 is reduced compared to the filling position shown in FIG. 7. To compact the collar 19, the second upper punch part 45 can be introduced in the mold cavity 43 of the die 39.

After an internal toothing is formed on the inner surface of the second upper punch part 45, as explained above, the first upper punch part 44 has an external toothing which engages with the internal toothing of the second upper punch part 45 in order to enable the height adjustment of the first upper punch part 44. In contrast, the corresponding surfaces between the first lower punch part 46 and the second lower punch part 47 do not have to have any toothing, since the first face toothing 15 of the sintered toothed belt wheel 5 can be formed with the internal toothing of the die 39. The outer lateral surface of the second lower punch part 47, on the other hand, has an external toothing which engages in the said internal toothing of the die 39 in order to enable the height adjustment of the lower punch 40.

Once compaction is complete, the green compact 49 is ejected from the device 38. This method step is shown in FIG. 10. To do this, the upper punch 41 is moved upwards. The green compact 49 can then be ejected, for example, by an upward movement of the first lower punch part 40.

The sintering of the green compact 49 can be carried out in one or more stages according to the state of the art. Reference is therefore made in this respect to the relevant state of the art. The temperatures during sintering may be between 750° C. and 1350° C., for example. The green compact 49 may be kept at this temperature for between 10 and 65 minutes.

The tapering of the collar head portion 22 and/or the rounding of the edges on the collar head portion 22 may take place during the pressing of the sintering powder 48 to form the green compact 49 by shaping the lower punch 40 and the upper punch 41 or their parts accordingly. Alternatively or additionally, the formation of the taper of the collar head portion 22 and/or the rounding of the edges on the collar head portion 22 may take place after ejection of the green compact 49 before and/or after sintering, for example as part of a calibration step. Preferably, the formation of the taper of the collar head portion 22 and/or the rounding of the edges on the collar head portion 22 is carried out chipless by pressing the material from one area into another area of the sintered toothed belt wheel 5 and/or by compacting the corresponding areas. Alternatively or additionally, the taper of the collar head portion 22 and/or the rounding of the edges on the collar head portion 22 may also be formed by machining.

The exemplary embodiments show or describe possible embodiment variants, wherein combinations of the embodiment variants are also possible.

Finally, for the sake of order, it should be noted that for a better understanding of the structure of the device 38 or the sintered toothed belt wheel 5, these are not necessarily shown to scale.

Although only a few embodiments of the present invention have been shown and described, it is to be understood that many changes and modifications may be made thereunto without departing from the spirit and scope of the invention.

### REFERENCE SIGNS LIST

1 belt-type rack-and-pinion drive
2 electric motor
3 electric motor
4 toothed belt
5 sintered toothed belt wheel
6 toothed belt
7 toothed wheel
8 toothed wheel
9 wheel body
10 axial direction
11 recess
12 shaft
13 lateral surface
14 track
15 face toothing
16 track
17 face toothing
18 end face
19 collar
20 end face
21 height
22 collar head portion
23 collar lateral surface
24 collar width
25 collar end face
26 collar end face
27 wall thickness
28 inner lateral surface
29 annular web
30 width
31 axis
32 distance
33 axis
34 diameter
35 diameter
36 tooth gaps
37 tooth gaps
38 device
39 die
40 lower punch
41 upper punch
42 core rod
43 mold cavity
44 upper punch part
45 upper punch part
46 lower punch part
47 lower punch part
48 sintering powder
49 green compact
50 pressing surface
51 pressing surface
52 distance
53 distance
54 pressing surface
55 pressing surface
56 end face
57 mold cavity
58 stepping

What is claimed is:

1. A sintered toothed belt wheel (5) with a one-piece, hollow cylindrical wheel body (9) on which a first track (14) and a second track (16) for toothed belts (4, 6) are formed, wherein the first track (14) has a first face toothing (15) and the second track (16) has a second face toothing (17), and wherein a collar (19) projecting beyond the tracks (14, 16) in the radial direction is formed between the first track (14) and the second track (16) with a collar head portion (22), wherein the collar head portion (22) is formed with a cross-sectional taper and/or with rounded edges.

2. The sintered toothed belt wheel (5) according to claim 1, wherein the collar (19) has a collar width (24) in the axial direction (10) through the sintered toothed belt wheel (5) which is selected from a range of 10 % to 350 % of a wall thickness (27) of the wheel body (9).

3. The sintered toothed belt wheel (5) according to claim 1, wherein an annular web (29) projecting radially inwards beyond the inner lateral surface (28) is arranged on an inner lateral surface (28) of the wheel body (9).

4. The sintered toothed belt wheel (5) according to claim 3, wherein the annular web (29) has a width (30) in the axial direction (10) through the sintered toothed belt wheel (5) which is selected from a range of 55 % to 700 % of the collar width (24).

5. The sintered toothed belt wheel (5) according to claim 3, wherein the neutral axis (31) through the annular web (29) in the axial direction (10) through the sintered toothed belt wheel (5) is offset at a distance of 2 % and 500 % of the collar width (24) from the neutral axis (33) through the collar (19).

6. The sintered toothed belt wheel (5) according to claim 1, wherein the first track (14) and the second track (16) are each configured as helical gearing and the two tracks (14, 16) form a double helical gearing.

7. The sintered toothed belt wheel (5) according to claim 1, wherein a tip circle of the first track (14) has a first diameter (34) and a tip circle of the second track (16) has a second diameter (35), wherein a ratio of the first diameter (34) to the second diameter (35) is selected from a range of 1:1 to 1:2.

8. The sintered toothed belt wheel (5) according to claim 1, wherein the tooth gaps (36) of the second track (16) are offset by a value relative to the tooth gaps (37) of the first track (14) which is selected from a range of 1 % to 99 %, based on the position of the tooth gaps (36) of the first track (14).

9. A belt-type rack-and-pinion drive (1) comprising a first motor, in particular an electric motor (2), and a second motor, in particular an electric motor (3), wherein the first motor is connected to a first toothed belt (4) with a sintered toothed belt wheel (5) and the second motor is connected to a second toothed belt (6) with a sintered toothed belt wheel (5) for torque transmission, wherein the sintered toothed belt wheel (5) is configured according to claim 1 and the first toothed belt (4) is in engagement with its first track (14) and the second toothed belt (6) is in engagement with its second track (16).

10. A method for producing a sintered toothed belt wheel (5), comprising the steps of: pressing a green compact (49) from a sintering powder (48) having a first track (14) and a second track (16), wherein the first track (14) has a first face toothing (15) and the second track (16) has a second face toothing (17), for which purpose the sintering powder (48) is filled into a mold cavity (43) of a die (39), and then the sintering powder (48) is pressed with an upper punch (41) and a lower punch (40) to form the green compact (49), and the sintering powder (48) is partially displaced into the upper punch (41) after being filled into the die (39) and the upper punch (41) is used as a further die for forming the first track (14), wherein a collar (19) with a collar head portion (22) is formed between the two tracks (14, 16) of the sintered toothed belt wheel (5) with the upper punch (41) and the lower punch (40), and the green compact (49) is then sintered, wherein the collar head portion (22) is formed with a cross-sectional taper and/or with rounded edges.
